(19) United States
(12) Patent Application Publication
(10) Pub. No.: US 2025/0035738 A1
(43) Pub. Date: Jan. 30, 2025

(54) METHOD AND SYSTEM FOR INTERFERENCE MITIGATION IN RADAR SIGNALS

(71) Applicant: Teraki GmbH, Berlin (DE)

(72) Inventors: Daniel Richart, Berlin (DE); Deniz Kumlu, Istanbul (TR); Ernesto Horne, Berlin (DE)

(73) Assignee: Teraki GmbH, Berlin (DE)

(21) Appl. No.: 18/782,452

(22) Filed: Jul. 24, 2024

Related U.S. Application Data
(60) Provisional application No. 63/529,345, filed on Jul. 27, 2023.

(51) Int. Cl. G01S 7/02; G01S 7/35; G01S 13/931

(52) U.S. Cl. CPC G01S 7/023; G01S 7/356; G01S 13/931

(57) ABSTRACT

A method of processing radar data includes detecting a received signal including one or more targets signals and interference, converting the received signal to a matrix signal, and decomposing the matrix signal into a low-rank matrix and a sparse matrix using a group sparsity based low-rank and sparse decomposition method. The method also includes computing an inverse transform of the low-rank matrix and outputting the one or more target signals.

### CROSS-REFERENCES TO RELATED APPLICATIONS

This application claims priority to U.S. Provisional Patent Application No. 63/529,345, filed on Jul. 27, 2023, entitled “Method and System for Interference Mitigation in Radar Signals,” the disclosure of which is hereby incorporated by reference in its entirety for all purposes.

### BACKGROUND OF THE INVENTION

Radar technologies have been widely used since World War II. However, more recently, commercial vehicles with radars were launched.

Due to their sensing and detection capabilities, together with their low cost, the number of in-vehicle radars is increasing along with the proliferation of autonomous cars. Generally, radar sensors operate in the same frequency bands, since the electromagnetic bandwidth spectrum dedicated to this industry is constrained between 76 and 81 GHz (and corresponding wavelengths between 4 and 3.7 mm).

Despite the progress made in the area of in-vehicle radars, there is a need in the art for improved methods and systems related to radars and interference mitigation in radar signals.

### SUMMARY OF THE INVENTION

Embodiments of the present invention relate to radar systems. More particularly, embodiments of the present invention provide methods and systems for mitigating interference in in-vehicle radars. In a specific embodiment, an efficient low-rank recovery method motivated by the group sparsity is utilized to identify targets from a received signal including both target signals and interference. The present invention is applicable to a variety of radar systems and in-vehicle radars are merely exemplary.

Numerous benefits are achieved by way of the present invention over conventional techniques. For example, embodiments of the present invention provide methods and systems that utilize a variety of different methods, including transformations based on short-time Fourier transforms and Hankel matrix lifting to convert a received signal with interference from a 1D signal to a 2D signal. Using methods based on robust principal component analysis, an interference mitigation approach for radars with sparse and low-rank Hankel matrix decomposition, and robust orthonormal subspace learning, embodiments of the present invention can decompose target signals that would otherwise be suppressed by interference. These, and other embodiments of the invention, along with many of its advantages and features, are described in more detail in conjunction with the text below and attached figures.

### BRIEF DESCRIPTION OF THE DRAWINGS

FIG. 1A illustrates different types of interference according to embodiments of the present invention.

FIG. 1B is a plot illustrating a dense matrix according to an embodiment of the present invention.

FIG. 1C is a plot illustrating a sparse matrix according to an embodiment of the present invention.

FIG. 1D is a plot illustrating a group sparse matrix according to an embodiment of the present invention.

FIG. 2 is a diagram illustrating a radar interference scenario according to an embodiment of the present invention.

FIG. 3A is a simplified plot illustrating a received 1D signal with interference according to an embodiment of the present invention.

FIG. 3B is a simplified plot illustrating target signals with no interference according to an embodiment of the present invention.

FIG. 3C is a simplified plot illustrating a Fourier Transform of the received signal with interference according to an embodiment of the present invention.

FIG. 3D is a simplified plot illustrating a Fourier Transform of the target signals with no interference according to an embodiment of the present invention.

FIG. 4A is a plot illustrating the STFT transform of the received 1D signal with interference according to an embodiment of the present invention.

FIG. 4B is a plot of the STFT transform of the target signals with no interference according to an embodiment of the present invention.

FIG. 4C is a plot illustrating the Hankel matrix lifting of the received signal with interference according to an embodiment of the present invention.

FIG. 4D is a plot of the Hankel matrix lifting of the target signals with no interference according to an embodiment of the present invention.

FIG. 5 is a simplified flowchart illustrating a method of mitigating radar interference according to an embodiment of the present invention.

FIG. 6A is a plot illustrating a received signal with moderate interference according to an embodiment of the present invention.

FIG. 6B is a plot illustrating target signals with no interference and mitigated signals according to an embodiment of the present invention.

FIG. 6C a plot illustrating target signals with no interference and mitigated signals over a sample range according to an embodiment of the present invention.

FIG. 7A is a plot illustrating the FFT of the received signal with interference according to an embodiment of the present invention.

FIG. 7B is a plot illustrating the FFT of the target signals with no interference according to an embodiment of the present invention.

FIG. 7C is a plot illustrating the FFT of the reconstructed target signal using the RPCA method in the short time Fourier transform implementation according to an embodiment of the present invention.

FIG. 7D is a plot illustrating the FFT of the reconstructed target signal using the ROSL method in the in the short time Fourier transform implementation according to an embodiment of the present invention.

FIG. 8A is a plot illustrating a received signal with moderate interference according to an embodiment of the present invention.

FIG. 8B is a plot illustrating target signals with no interference and mitigated signals according to an embodiment of the present invention.

FIG. 8C a plot illustrating target signals with no interference and mitigated signals over a sample range according to an embodiment of the present invention.

FIG. 9A is a plot illustrating the FFT of the received signal with interference according to an embodiment of the present invention.

FIG. 9B is a plot illustrating the FFT of the target signals with no interference according to an embodiment of the present invention.

FIG. 9C is a plot illustrating the FFT of the reconstructed target signal using the RPCA method in the Hankel matrix lifting implementation according to an embodiment of the present invention.

FIG. 9D is a plot illustrating the FFT of the reconstructed target signal using the IM-SPARKLE method in the Hankel matrix lifting implementation according to an embodiment of the present invention.

FIG. 9E is a plot illustrating the FFT of the reconstructed target signal using the ROSL method in the Hankel matrix lifting implementation according to an embodiment of the present invention.

FIG. 10A is a plot illustrating a received signal with extreme interference according to an embodiment of the present invention.

FIG. 10B is a plot illustrating target signals with no interference and mitigated signals according to an embodiment of the present invention.

FIG. 10C a plot illustrating target signals with no interference and mitigated signals over a sample range according to an embodiment of the present invention.

FIG. 11A is a plot illustrating the FFT of the received signal with interference according to an embodiment of the present invention.

FIG. 11B is a plot illustrating the FFT of the target signals with no interference according to an embodiment of the present invention.

FIG. 11C is a plot illustrating the FFT of the reconstructed target signal using the IM-SPARKLE method in the Hankel matrix lifting implementation according to an embodiment of the present invention.

FIG. 11D is a plot illustrating the FFT of the reconstructed target signal using the ROSL method in the Hankel matrix lifting implementation according to an embodiment of the present invention.

FIG. 12A is a plot illustrating a received signal with interference according to an embodiment of the present invention.

FIG. 12B is a plot illustrating target signals with no interference and mitigated signals according to an embodiment of the present invention.

FIG. 12C a plot illustrating target signals with no interference and mitigated signals over a sample range according to an embodiment of the present invention.

FIG. 13A is a plot illustrating the FFT of the received signal with interference according to an embodiment of the present invention.

FIG. 13B is a plot illustrating the FFT of the target signals with no interference according to an embodiment of the present invention.

FIG. 13C is a plot illustrating the FFT of the reconstructed target signal using the IM-SPARKLE method in the Hankel matrix lifting implementation according to an embodiment of the present invention.

FIG. 13D is a plot illustrating the FFT of the reconstructed target signal using the ROSL method in the Hankel matrix lifting implementation according to an embodiment of the present invention.

FIG. 14A is a plot illustrating the received signal with interference according to an embodiment of the present invention.

FIG. 14B is a plot illustrating the location of interfered samples according to an embodiment of the present invention.

FIG. 15A is a plot illustrating a received signal with interference according to an embodiment of the present invention.

FIG. 15B is a plot showing the decomposition of the sparse part of the received signal with interference according to an embodiment of the present invention.

FIG. 15C is a plot showing the decomposition of the low-rank part of the received signal with interference according to an embodiment of the present invention.

FIG. 16A is a plot illustrating the FFT of the received signal with interference according to an embodiment of the present invention.

FIG. 16B is a plot illustrating the FFT of the received signal with interference after application of a zeroing method.

FIG. 16C is a plot illustrating the FFT of the received signal with interference after application of the IM-SPARKLE method according to an embodiment of the present invention.

FIG. 16D is a plot illustrating the FFT of the received signal with interference after application of the ROSL method according to an embodiment of the present invention.

FIG. 17A is a plot illustrating a received signal with interference according to an embodiment of the present invention.

FIG. 17B is a plot of interfered samples according to an embodiment of the present invention.

FIG. 18A is a simplified schematic diagram including data plots illustrating a conventional radar signal processing pipeline.

FIG. 18B is a simplified schematic diagram including data plots illustrating a radar signal processing pipeline according to an embodiment of the present invention.

FIG. 19 is a simplified block diagram illustrating components of a radar signal processing according to an embodiment of the present invention.

### DETAILED DESCRIPTION OF THE INVENTION

Embodiments of the present invention relate to radar systems. More particularly, embodiments of the present invention provide methods and systems for mitigating interference in in-vehicle radars. In a specific embodiment, a low-rank and sparse decomposition method is utilized to identify targets from a received signal including both target signals and interference. The present invention is applicable to a variety of radar systems and in-vehicle radars are merely exemplary.

Today, many cars are equipped with multiple radar sensors. When multiple vehicles sensors are active, it is unavoidable to observe interference between these radars. This is an increasingly problematic effect observed in radar detection, and it is especially critical in dense traffic situations.

Herein, the principles of radar detection are discussed to understand the source of radar interference before introducing embodiments on the present invention that mitigate radar interference, thereby revolutionizing the radar automotive industry.

The working principle of radars is rather simple: the automotive radar works as both a transceiver and receiver of electromagnetic waves in the radar spectrum. The radar emits a wave. This wave propagates freely in the air until it finds an object where it is partially reflected, then it propagates back to the sensor (and in many other directions) where the target is identified through the physical characteristics of the wave.

The process used to identify the reflected wave can vary, but what is common to almost all automotive radars is the use of frequency-modulated waveforms. The frequency of the waveform is increased linearly with time to form what is known as a chirp. This particular waveform shape allows a rapid comparison between the emitted wave and the incoming waves by using heterodyne detection, i.e., multiplication between emitted and received signals.

The radial distance between the sensor and the object will be related to the frequency of the resulting plane wave. This concept can be extended to multiple targets simply by considering the resulting wave as an addition of multiple plane waves, each one containing a given frequency associated with the distance of the reflecting object. Through standard methods, as for example, a Fast Fourier transform, the frequency spectrum can be obtained to identify the radial distance of the targets.

One of the characteristics that make radars outstanding as a sensor is its ability to measure radial velocities of the detected targets with a high precision. By high precision, it is meant that it is more accurate than if we would compute the position obtained in two consecutive chirps and divide the distance between these positions by the interval of time that separates both chirps.

The reason this is possible is given by the fact that we can measure the distance of the targets by using two independent “rulers.” The first “ruler,” already mentioned, is the measurement of the frequency of the plane wave. The second “ruler” is using the change of the argument of the trigonometric function given by the changes in phase. The phase of the wave has a remarkably high sensitivity to displacements, given that the typical wavelengths of automotive radars are 4 mm. Therefore, by measuring a target through multiple chirps, the radar can measure its relative displacement and estimate the radial speed of the target within a certitude of (O(1 mm)/N_{c})/(T_{c}), where N_{c} is the number of chirps per frame and T_{c} the time between chirps.

Computation of the angle can use the high distance resolution obtained through changes in phase. But, instead of comparing two consecutive chirps in time, the same chirp is compared by being measured by two receivers spatially displaced by a fixed distance. Therefore, a modification in the phase would indicate a modification of the distance of the target from multiple points of view and indicate the angle of arrival of the wave from a given target. This is analogous to the way animals use two eyes to identify distance, angles, and depth.

### Radar-Radar Interference

As mentioned previously, the radar wave travels to an object where it is reflected, detected by the sensor, and compared with the original wave to estimate its displacement. This is quite clear in the temporal domain. The following discusses how the intensity of the wave is modified through its trajectory.

The wave is degraded at several instances: propagation, reflection, scattering, etc. The wave is almost not affected in the propagation stage, yet when it reaches the object, it is eroded by the reflectivity of the object (rarely a perfect mirror) and by the fact that the reflection occurs in multiple directions. This degradation of the wave can be seen mostly in the intensity (amplitude) of the wave. Finally, the incoming wave is therefore amplified to be able to compare it with the emitted wave.

In the case of multiple radar sources, parasite signals coming from other radars can be interpreted as an own source reflected wave. This will have an effect of producing ghost targets (non-existing targets) through misinterpretation of its frequency in the first place and, as the intensity of the parasite wave is not eroded by any reflection, the signal containing real reflections can be completely covered by the contribution of the parasite wave. Accordingly, embodiments of the present invention implemented interference mitigation methods that are based, at least in part, on an understanding of the effects of noise in the radar pipeline.

The number of radars are increasing with the spread of autonomous vehicles due to their sensing/detection capabilities with respect to the other sensors that equipped in the cars. In most of the use cases, these radar sensors are operating in the same or similar frequency bands since there is allocated spectrum in the range of 76-81 GHz. In near future, many cars will be equipped with multiple radar sensors and there is high probability that sensors will interfere with each other using current designs. The problem is especially critical in dense traffic situations.

The inventors have determined that there are three different types of interference:
Self-interference, caused by a strong return signal reflected by the platform (the radome or the bumper) or the coupling (spill-over) effect between transmitter and receiver;
Cross-interference caused by multiple transceivers on the same vehicle, or within the same transceiver such as with a multiple input multiple output (MIMO) system; and
Interference caused by other radars in the vicinity.

Two approaches can be used for interference mitigation: reactive and proactive. Reactive approaches aim to mitigate the interference after it has occurred and proactive approaches aim to avoid or mitigate interference based on system design. Some embodiments of the present invention utilize reactive approaches as described more fully herein.

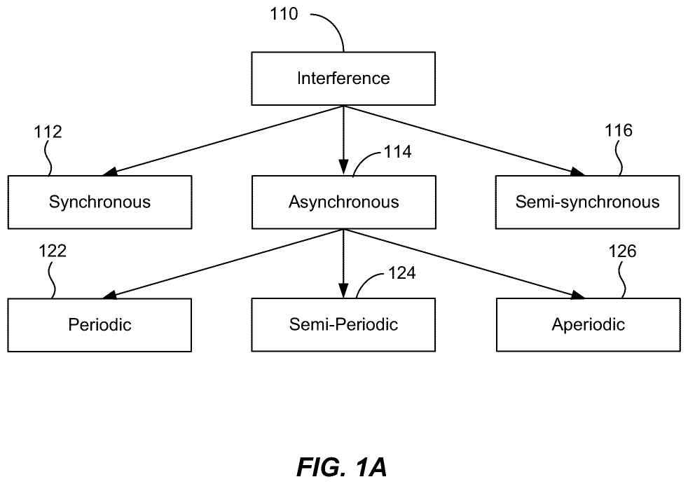

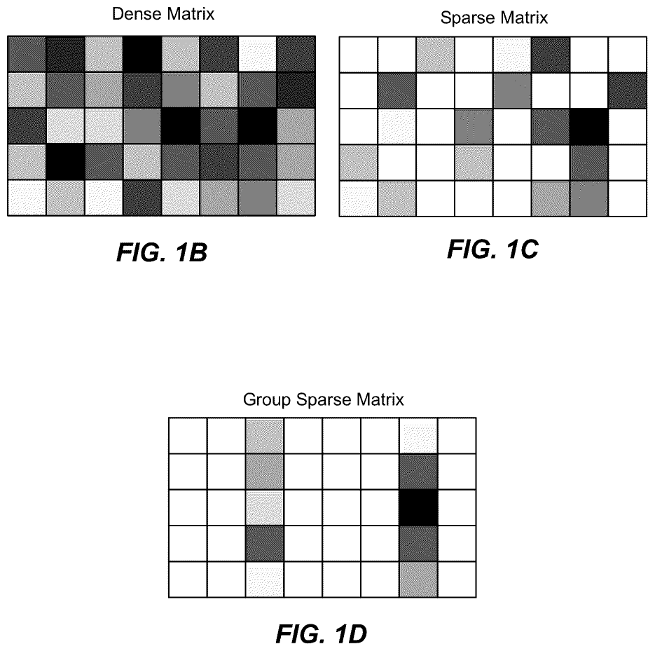

FIG. 1A illustrates different types of interference according to embodiments of the present invention. Referring to FIG. 1A, interference 110 can be synchronous interference 112, asynchronous interference 114, or semi-synchronous interference 116. Interference can saturate the receiver, produce ghost target phenomenon, and increase the noise floor. Asynchronous interference 114 can be periodic 122, semi-periodic 124, or aperiodic 126.

The description provided herein focuses on direct interference from one radar to another. Indirect interference (i.e., resulting from scattering off of objects) will be weaker and is ignored for simplicity. As described more fully herein, low-rank and sparse decomposition (LRSD) methods are used to implement signal separation functions and have been demonstrated by the inventors to provide superior results.

### Denoising, Interference Mitigation, and Target Detection

Generally, interference is much stronger than the desired back-scattered signal according to the Friis space propagation equation. The nature of the interference is correlated with the total interference power and the level of synchronicity between victim and interfering radar (i.e., aggressor radar). Thus, the reflection from the target can be dominated by the interference according to its nature.

The received radar signal is a 1D vector and can be represented by x with dimensions N×1. It can be real or complex and contains coefficients with different amplitudes.

In order to apply LRSD-based matrix decomposition methods, the received 1D radar signal is converted into a 2D matrix. This enables the target or the interference to be represented as a sparse component in the 2D matrix. In frequency modulated continuous wave (FMCW) radars, the beat signal could be sparse in the frequency domain. However, the interference at the analog-to-digital converter (ADC) output, generally exhibits sparsity in the time-, frequency-, or time-frequency domain in various scenarios.

The received 1D radar signal x is converted into 2D form and can be represented by X. This conversion can be done via one of several methods, including a short-time Fourier transform (STFT), Hankel matrix, or the like, which result in the 2D conversion being sparse.

After this conversion, the problem formulation of the interference mitigation can be converted into a signal separation problem via LRSD methods.

In LRSD methods, the input matrix can be modeled as the superposition of multiple signals that correspond to low-rank and sparse components of the input and can be given as follows:

$$X = L + S \qquad ( 1 )$$

where L∈ [symbol] and S∈ [symbol] correspond to target and interference components, respectively. L (i.e., the target component) and S (i.e., the interference component) can be recovered from the input data matrix X∈ [symbol] via rank minimization. Since this problem is non-convex, a convex solution may be obtained by nuclear norm minimization. Robust principal component analysis (RPCA) solves this minimization as:

$$\begin{matrix}min \\ L , S\end{matrix} {‖ L ‖}_{*} + λ {‖ S ‖}_{1} s . t . X = L + S \qquad ( 2 )$$

where ∥·∥*, ∥·∥₁ and λ are the nuclear norm, L1-norm, and the penalization parameter, respectively. RPCA is computationally expensive due to the use of iterative singular value decomposition (SVD) operations. For the rank minimization problem, one may use a non-convex matrix factorization for fast, low-rank recovery.

Robust orthonormal subspace learning (ROSL) offers a solution for computationally efficient low-rank recovery motivated by the group sparsity by modeling the low-rank part under an orthonormal subspace such as:

$$D = [ {D}_{1} , {D}_{2} , … , {D}_{k} ] ∈ {ℝ}^{M \times k} \qquad ( 3 )$$

$$and$$

$${D}^{T} D = I$$

L is given as

$$L = D α \qquad ( 4 )$$

The rank of L, i.e., the sparse coefficient vector α, is upper bounded by the number of non-zero rows of α defined as ∥α∥_{row-0}.

L and S are recovered by:

$$\begin{matrix}min \\ S , D , α\end{matrix} {‖ α ‖}_{row - 0} + λ {‖ S ‖}_{0} s . t . D α + S = X , \qquad ( 5 )$$

$${D}^{T} D = 1$$

where λ is the penalization parameter.

Using L1-norm as a relaxation for NP hard L0-norm and group sparsity ∥α∥_{row-1} for ∥α∥_{row-0}, the final form becomes:

$$\begin{matrix}min \\ S , D , α\end{matrix} {‖ α ‖}_{row - 1} + λ {‖ S ‖}_{1} s . t . D α + S = X , \qquad ( 6 )$$

$${D}^{T} D = 1$$

Here, ∥α∥_{row-1} is defined as Σᵢ₌₁^{k}∥αᵢ∥₂ and equation (6) can be solved by an augmented Lagrangian method.

In the context of the ROSL method:
X∈ [symbol] is the 2D matrix after STFT or Hankel matrix lifting conversion. L and S are low-rank and sparse matrices, respectively.

$$X = L + S$$

$$X = D α + S$$

Group sparsity is a variant of sparsity that can be applied to matrix decomposition problems. Group sparsity is a form of structured sparsity that organizes variables into groups, and then promotes sparsity on the group level rather than on the individual variable level. The concepts are applied herein since, in certain applications, some features (or variables) have natural groupings. In embodiments of the present invention, different target or interference sources constitute different groups.

When a group sparsity constraint is applied, it encourages the entire group of variables to be either selected or removed together. This means that if one variable in the group is non-zero, then the entire group of variables is likely to be non-zero. Conversely, if one variable in the group is zero, then the entire group is likely to be zero.

FIG. 1B is a plot illustrating a dense matrix according to an embodiment of the present invention. FIG. 1C is a plot illustrating a sparse matrix according to an embodiment of the present invention. FIG. 1D is a plot illustrating a group sparse matrix according to an embodiment of the present invention.

In the context of matrix decomposition, for example, you can group the columns of a matrix together, and the group sparsity constraint will make entire columns (i.e., groups) become zero vectors. This means that if one element in the column is non-zero, then it is likely that the entire column is non-zero.

In the context of ROSL, group sparsity can be used to ensure that a small number of subspace bases (columns of the factorization matrices) are used to represent the data. In ROSL, the coefficient matrix α is the sparse representation of the low-rank matrix L in the subspace D.

The a matrix plays a crucial role in group sparsity and how the sparse points are grouped together.

The sparsity of α is enforced by encouraging a smaller number of non-zero rows in the matrix. Each row of α corresponds to a group or subset of coefficients associated with a specific basis vector in the subspace D. By limiting the number of non-zero rows in α, ROSL promotes the selection of only a few groups or subsets of coefficients, effectively grouping the sparse points together.

The specific groups or subsets of coefficients that are selected depend on the underlying structure and characteristics of the data. The algorithm aims to identify the most relevant groups that represent meaningful features or patterns in the matrix L. By promoting group sparsity in α, ROSL encourages the grouping of these relevant sparse points together, while leaving other groups of coefficients as zero or negligible.

The process of group sparsity in ROSL allows for the identification and extraction of specific subsets of coefficients that collectively represent certain structures or components in the low-rank matrix. By grouping the sparse points together, ROSL facilitates a more compact and interpretable representation of the underlying data, leading to improved matrix decomposition and analysis.

In ROSL, group sparsity is applied to matrix decomposition to recover a low-rank matrix L from a given matrix X. ROSL enforces group sparsity by constraining the coefficients α, which represent the decomposition of L in terms of a subspace D.

The following provides an overview of how group sparsity is applied in ROSL:
1. Define the subspace and coefficients: ROSL starts by defining a subspace D and the coefficients α such that A=Dα. The goal is to recover the low-rank matrix L.
2. Sparsity constraint on α: ROSL imposes a sparsity constraint on the coefficients α to achieve group sparsity. The main idea is that the rank of L (or α) is bounded by the number of non-zero rows in α. In other words, ROSL aims to minimize the number of non-zero rows in α, which corresponds to identifying the groups of coefficients that are non-zero.
3. Orthonormality constraint on D: To ensure that the group sparsity of α is a valid measure of rank(L), ROSL enforces the orthonormality constraint on the subspace D. This means that the columns of D should be orthogonal to each other, which is expressed as D^{T}D=Iₖ, where Iₖ is an identity matrix. By constraining D to be orthonormal, ROSL eliminates the correlation between the columns of D, which helps in identifying the distinct groups in α.
4. Optimization: ROSL formulates an optimization problem to recover the low-rank matrix L. The objective function typically involves minimizing the number of non-zero rows in a and promoting the sparsity of another term S. The optimization problem can be solved using various techniques, such as convex optimization methods or iterative algorithms.

By incorporating these group sparsity constraints and optimization procedures, ROSL aims to decompose the given matrix X into a low-rank matrix L and a sparse error matrix S. The group sparsity constraint helps in identifying the relevant groups or subsets of coefficients that contribute to the low-rank structure of L, while promoting sparsity in S to capture the noise or outliers in the data.

Another approach is the use of a sparse and low-rank Hankel matrix decomposition and definition of the minimization function as follows:

$$\{ L , S \} = \begin{matrix}min \\ L , S\end{matrix} {‖ L ‖}_{*} + λ {‖ S ‖}_{1} s . t . {‖ X - L - S ‖}_{F}^{2} \leq ε L , S ∈ H \qquad ( 7 )$$

Since RPCA is computationally expensive, especially for the larger matrices, the problem can be simplified with minor modifications as discussed herein.

As described more fully below, the inventors analyzed and present several scenarios to show an increasing noise floor (i.e., missing the target), a ghost target, and saturation of the receiver.

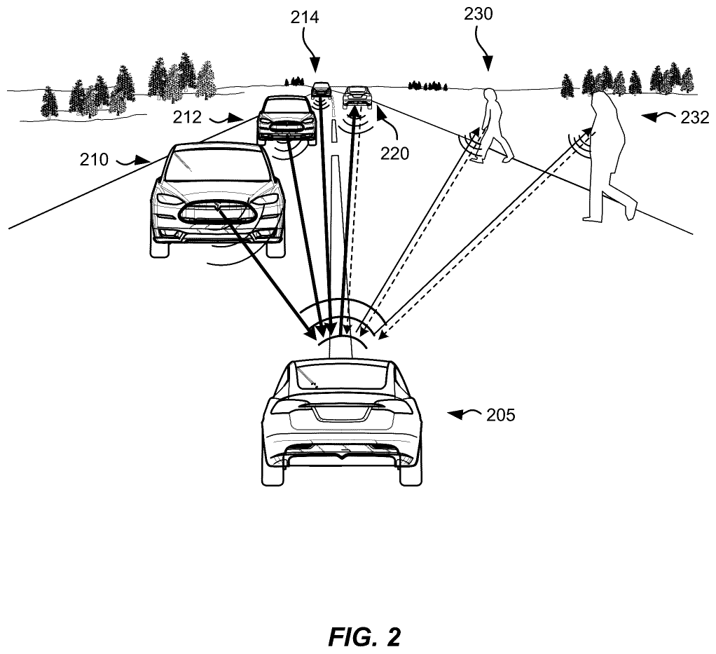

FIG. 2 is a diagram illustrating a radar interference scenario according to an embodiment of the present invention. As illustrated in FIG. 2, three aggressor radars 210, 212, and 214 and three different targets, including a car 220 and two pedestrians 230 and 232, are present. Radar signals from these sources is received at vehicle 205. This scenario depicts the increasing noise floor (i.e., missing targets) case. Our expectation is that the back-scattered signal from the weak targets will be hidden under the interference signals.

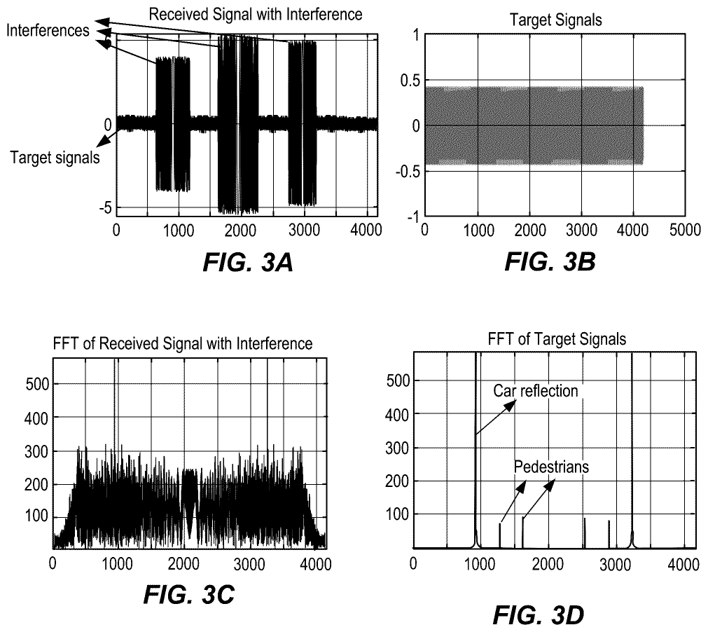

FIG. 3A is a simplified plot illustrating a received 1D signal with interference according to an embodiment of the present invention.

FIG. 3B is a simplified plot illustrating target signals with no interference according to an embodiment of the present invention. FIG. 3B shows the result that is achieved if the three aggressor radars are removed from the scenario, with the received signal corresponding to the illustrated signal. The illustrated signal can be compared to the ground-truth signal.

FIG. 3C is a simplified plot illustrating a Fourier Transform (e.g., a fast Fourier transform (FFT)) of the received signal with interference according to an embodiment of the present invention.

FIG. 3D is a simplified plot illustrating a Fourier Transform of the target signals with no interference according to an embodiment of the present invention.

Referring to FIGS. 3A-3D, which correspond to the scenario illustrated in FIG. 2, FIG. 3A shows that there are three interference signals as well as the three underlying target signals. FIG. 3B illustrates that superposition of the three target signal is observed. If there are no aggressor radars in the vicinity of the vehicle, the received signals correspond to the plot shown in FIG. 3B. In FIGS. 3C and 3D, the Fourier Transform (e.g., an FFT) of the received signal with interference (FIG. 3C) and the target signals (FIG. 3D) are taken and their results are shown, respectively. As can be seen in FIG. 3C, the reflections that belong to the pedestrians 230 and 232 are hidden in the noise floor and there are false alarms that are produced. In FIG. 3D, the three targets (i.e., the car 220 and the pedestrians 230 and 232) are clearly observed since there are no aggressor radars present in this scenario. The FFT illustrated in FIG. 3D is symmetric, resulting in the target signals corresponding to the car 220 and the pedestrians 230 and 232 being mirrored around sample number 2180.

As discussed above, the received 1D signal can be converted into a 2D matrix by applying a variety of methods, including methods that meet some of the previously mentioned requirements, including sparsity (i.e., the sparse representation may be used instead of sparsity).

In some embodiments, after 2D transformation via STFT or Hankel matrix, LRSD based methods are applied to the 2D transformation.

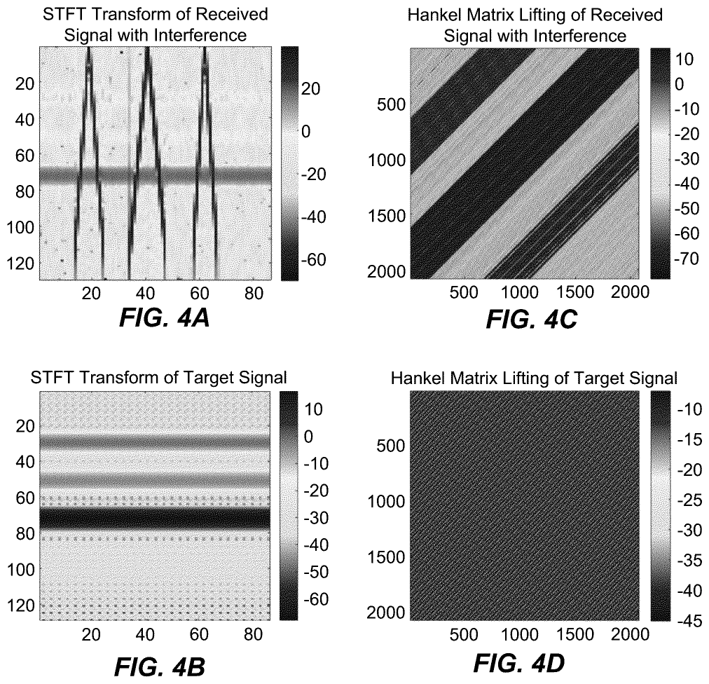

FIG. 4A is a plot illustrating the STFT transform of the received 1D signal with interference according to an embodiment of the present invention. FIG. 4B is a plot of the STFT transform of the target signals with no interference according to an embodiment of the present invention. As illustrated in FIG. 4A, the interference signals are characterized by a “V” shape and the targets are represented by a “horizontal line.” Since the interference is much stronger compared to the targets, they are more intense in the color space. In addition, the pedestrians are barely visible in the STFT domain.

FIG. 4C is a plot illustrating the Hankel matrix lifting of the received signal with interference according to an embodiment of the present invention. FIG. 4D is a plot of the Hankel matrix lifting of the target signals with no interference according to an embodiment of the present invention. For the Hankel matrix approach, the interference has a diagonal like structure and the target is spread over the background.

Thus, the 2D transformations of the target signals illustrated in FIGS. 4B and 4D demonstrate that the target signals have low-rank and the interference signals have sparse structures.

In the description below, several methods will be applied to the 2D transformed signals for different scenarios. The initial scenario is illustrated in FIG. 2, which includes three targets and three interference sources.

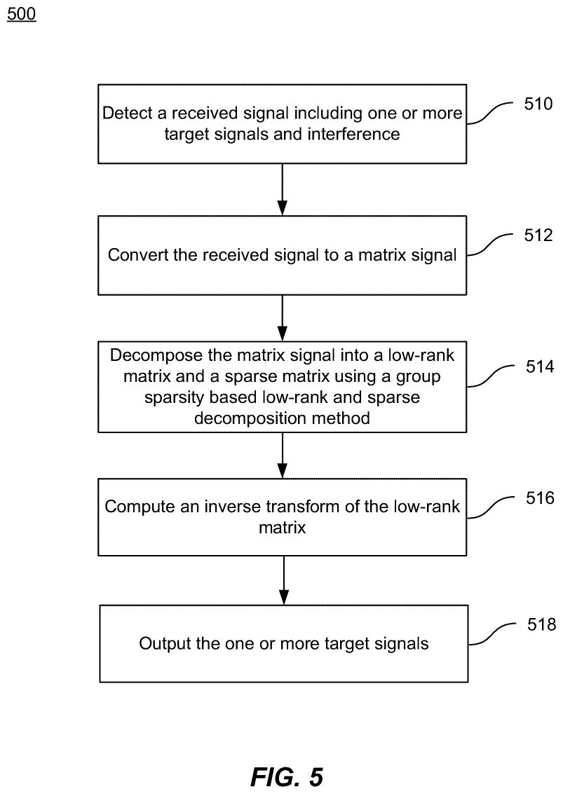

FIG. 5 is a simplified flowchart illustrating a method of mitigating radar interference according to an embodiment of the present invention. Referring to FIG. 5, a method of processing radar data is provided. The method 500 includes detecting a received signal including one or more targets signals and interference (510) and converting the received signal to a matrix signal (512). The received signal can be a one-dimensional signal and the matrix signal can be a two-dimensional signal. Converting the received signal to a matrix signal can include performing a short time Fourier transform on the received signal. In this case, the inverse transform comprises an inverse short time Fourier transform. Alternatively, converting the received signal to a matrix signal can include performing Hankel matrix lifting on the received signal. In this case, the inverse transform comprises an inverse Hankel matrix lifting.

The method also includes decomposing the matrix signal into a low-rank matrix and a sparse matrix using a group sparsity based low-rank and sparse decomposition method (514), computing an inverse transform of the low-rank matrix (516), and outputting the one or more target signals (518). The low-rank matrix corresponds to the one or more target signals and the sparse matrix corresponds to the interference. As an example, the interference can correspond to three or more interference sources. The method can also include determining that interference is present in the received signal. For instance, determining that the interference is present in the received signal can include using a constant false alarm method.

As described herein, after 2D conversion (STFT or Hankel matrix lifting) and decomposition as illustrated in FIGS. 4C and 4D, the inverse transform of the low-rank signal (corresponding to the target) is taken to return to a 1D signal, illustrated by FIG. 3B, which illustrates the target signal with the interference removed. This 1D signal is then utilized in the remainder of the radar signal processing pipeline. By removing the interference, performance in the remainder of the pipeline is improved compared with conventional methods. Referring to FIG. 5, the inverse transform computed at step 516 is the inverse of the matrix conversion performed at step 512 and produces a signal corresponding to the received signal with the interference removed (i.e., the target signals) as illustrated in FIG. 3B.

It should be appreciated that the specific steps illustrated in FIG. 5 provide a particular method of processing radar data according to an embodiment of the present invention. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

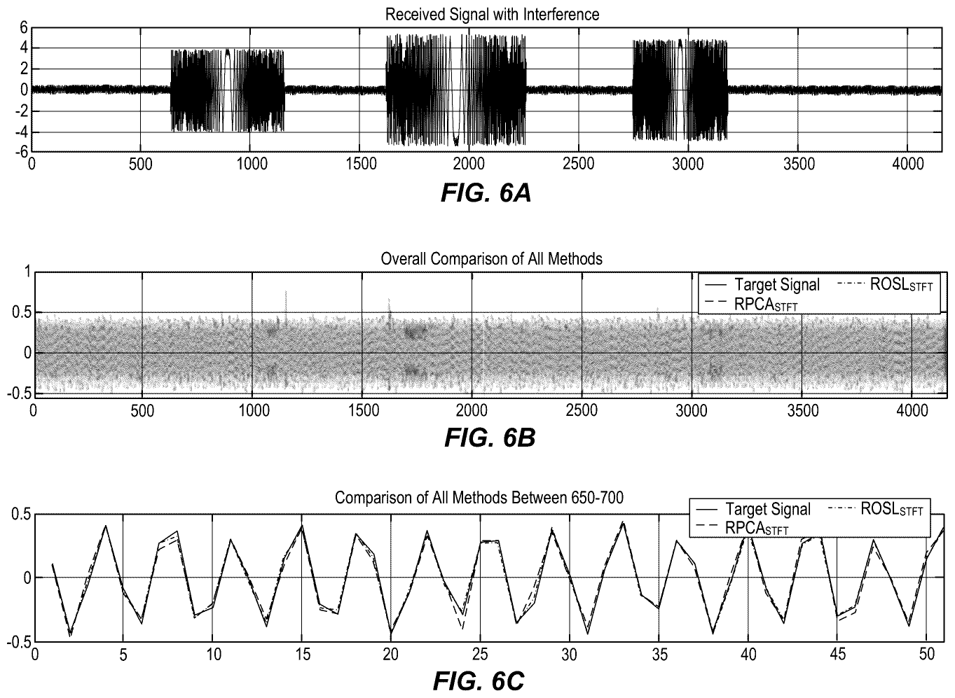

FIG. 6A is a plot illustrating a received signal with moderate interference according to an embodiment of the present invention. As illustrated in FIG. 6A, a number of samples (e.g., 4160 samples) are collected over a time period. The target signals and interfering signals are both represented in the sample values plotted in FIG. 6A. An STFT transform is applied to the data illustrated in FIG. 6A to produce a 2D matrix. It will be noted that since the Interference Mitigation approach for radars with SPArse and low-Rank HanKeL matrix dEcomposition (IM-SPARKLE) is solely design for Hankel matrix operations, it is not used in this STFT transform implementation.

FIG. 6B is a plot illustrating target signals with no interference and mitigated signals according to an embodiment of the present invention. As shown in FIG. 6B, RPCA and ROSL methods are used for the LRSD purposes. Thus, in FIG. 6B, the overall reconstruction results of the RPCA and ROSL methods are plotted along with the original target signal. As observed from the overall plots, the RPCA results are characterized by some spikes and generally exceeds the boundary lines of the original target signal. On the other hand, the ROSL results are characterized by some distortion in the interference parts of the received signal. Thus, FIG. 6B illustrates the result of the methods described herein for the baseline and an embodiment of the present invention. Since a 2D transformation STFT is used, then RPCA and ROSL is implemented. Then an inverse transform is applied to obtain a low rank signal. The plot in FIG. 6B shows a low rank decomposed signal for the full range of samples (0-4000).

FIG. 6C a plot illustrating target signals with no interference and mitigated signals over a sample range according to an embodiment of the present invention. In FIG. 6C, the reconstructed signal over the sample range of 650-700 samples is illustrated for better visual perception (i.e., FIG. 6C is the zoomed version for a certain area to better illustrate the overlap between the original target signal and the reconstructed signal). As can be seen from the results, the results of the ROSL method has similar characteristics to original target signal, however the results of the RPCA method is characterized by some inaccuracy on the corner points. Thus, using the STFT transformation, the inventors have demonstrated that the ROSL method outperforms the RPCA method in this domain given that both methods do not produce perfect reconstruction in some implementations.

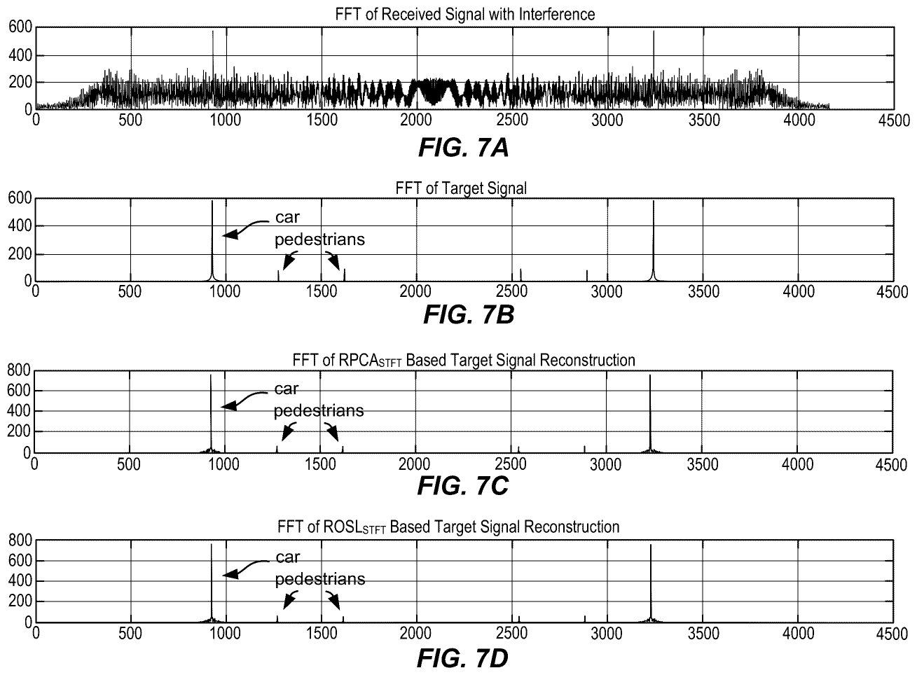

FIG. 7A is a plot illustrating the FFT of the received signal with interference according to an embodiment of the present invention. As can be seen from the data illustrated in FIG. 7A, the target signals corresponding to the two pedestrians are not observed in the data since there is a high noise floor.

FIG. 7B is a plot illustrating the FFT of the target signals with no interference according to an embodiment of the present invention. If there is no interference in the received signal, then the FFT of the target signal correspond to the data illustrated in FIG. 7B. Thus, this plot provides a baseline against which the reconstructed signals can be compared. In other words, this plot indicates a ground truth for the signal simulation, since in this case only the target signal is simulated without interference.

FIG. 7C is a plot illustrating the FFT of the reconstructed target signal using the RPCA method in the short time Fourier transform (STFT) implementation according to an embodiment of the present invention. FIG. 7D is a plot illustrating the FFT of the reconstructed target signal using the ROSL method in the in the short time Fourier transform implementation according to an embodiment of the present invention. These plots illustrate the FFT results after interference mitigation via the RPCA method and the ROSL method provided by embodiments of the present invention, respectively. As an example, the data illustrated in FIGS. 7C and 7D can be produced by taking the FFT of the target signals illustrated in FIG. 3B after either the RPCA method or the ROSL method, respectively, has been utilized to produce the target signals. As can be seen from these results, there is some minor noise in the vicinity of the targets however, all the three targets are clearly observed as in the original target signal case illustrated in FIG. 7B. In particular, the target signal corresponding to the car is present at ˜950 samples and the targets corresponding to the two pedestrians are present at ˜1300 samples and ˜1600 samples. Thus, STFT transformation based interference mitigation is quite effective as demonstrated by FIGS. 6C, 7C, and 7D.

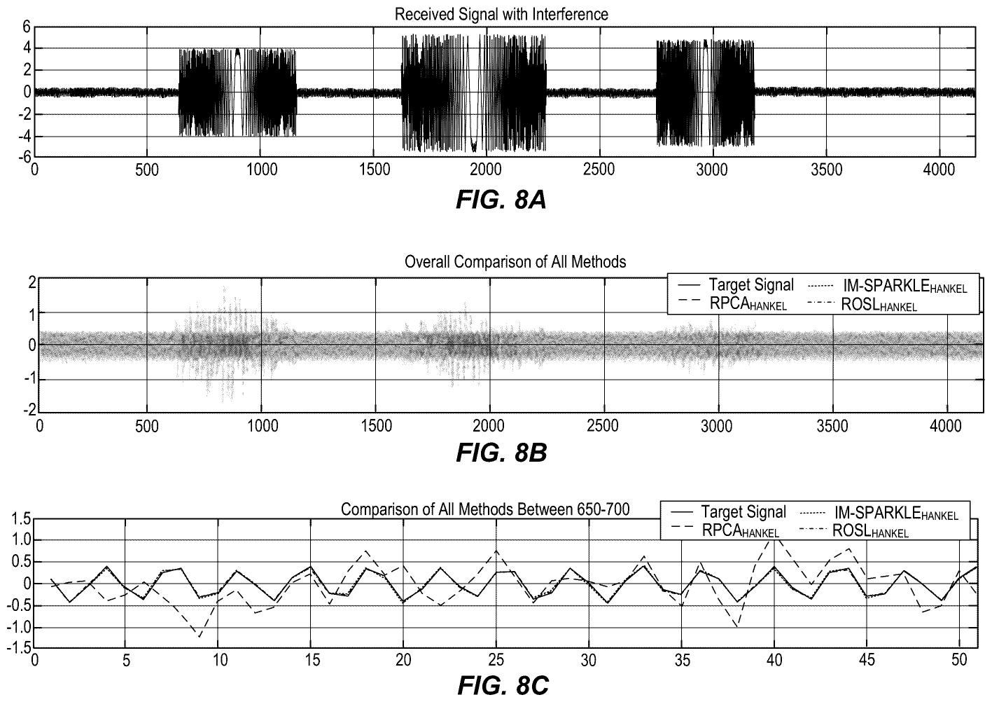

FIG. 8A is a plot illustrating a received signal with moderate interference according to an embodiment of the present invention. FIG. 8A corresponds to FIG. 6A. Hankel matrix lifting is applied to the data illustrated in FIG. 8A to produce a 2D matrix. Because IM-SPARKLE is designed for Hankel matrix operations, IM-SPARKLE results are shown as well as results produced using the RPCA methods as well as results produced using the ROSL method.

FIG. 8B is a plot illustrating target signals with no interference and mitigated signals according to an embodiment of the present invention. As discussed in relation to FIG. 6B, the plot illustrated in FIG. 8B is for a reconstructed signal. As shown in FIG. 8B, IM-SPARKLE, RPCA, and ROSL methods are used for the LRSD purposes. Thus, in FIG. 8B, the overall reconstruction results of the IM-SPARKLE, RPCA, and ROSL methods are plotted along with the original target signal. As observed from the overall plots, the RPCA results are characterized by some distortion in the interference parts of the received signal.

FIG. 8C a plot illustrating target signals with no interference and mitigated signals over a sample range according to an embodiment of the present invention. In FIG. 8C, the reconstructed signal over the sample range of 650-700 samples is illustrated, providing a zoomed version similar to that shown in FIG. 6C to better illustrate the overlap between the original target signal and the reconstructed signal. As can be seen from the results, the results of the RPCA method is characterized by significant distortion since this portion of the zoomed area corresponds to the interference part of the received signal. However, both IM-SPARKLE and the ROSL methods show satisfactory reconstruction results for the Hankel matrix lifting transformation. The results illustrated in FIG. 8C are slightly better than the results illustrated in FIG. 6C. Thus, it can be concluded that, in this embodiment, Hankel matrix lifting has better sparse representation compared to the STFT transformation.

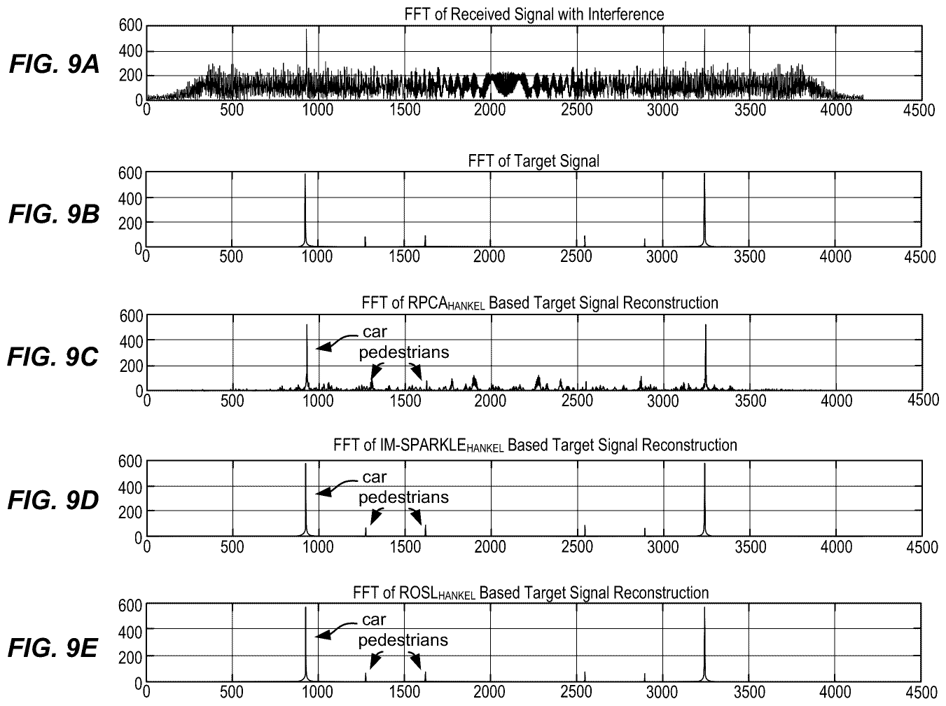

FIG. 9A is a plot illustrating the FFT of the received signal with interference according to an embodiment of the present invention. FIG. 9A corresponds to FIG. 7A. As can be seen from the data illustrated in FIG. 9A, the target signals corresponding to the two pedestrians are not observed in the data since there is a high noise floor.

FIG. 9B is a plot illustrating the FFT of the target signals with no interference according to an embodiment of the present invention. FIG. 9B corresponds to FIG. 7B. Thus, this plot provides a baseline against which the reconstructed signals can be compared.

FIG. 9C is a plot illustrating the FFT of the reconstructed target signal using the RPCA method in the Hankel matrix lifting implementation according to an embodiment of the present invention. FIG. 9D is a plot illustrating the FFT of the reconstructed target signal using the IM-SPARKLE method in the Hankel matrix lifting implementation according to an embodiment of the present invention. FIG. 9E is a plot illustrating the FFT of the reconstructed target signal using the ROSL method in the Hankel matrix lifting implementation according to an embodiment of the present invention.

As can be seen from these results, the IM-SPARKLE and ROSL methods have almost perfect reconstruction results while the RPCA method produces less accurate results. There is an observable noise floor using the RPCA method. This noise floor is not desired since it hides weak target signals, e.g., the weak target signals corresponding to the pedestrians. However, the weak target signals are easily observable in the results achieved using the IM-SPARKLE and ROSL methods.

The computational complexity of the methods discussed above are presented in Table 1. As can be seen from Table 1, the RPCA method has the highest complexity of the various methods. Additionally, the ROSL method has lower complexity than the IM-SPARKLE method.

TABLE 1
Computational complexity of various methods

| Method | Complexity |
|---|---|
| RPCA | O(min(M²N, M N²)) |
| IM-SPARKLE | O(MN(4r + 5) + 2(M + N + 1)r² + 2r³) |
| ROSL | O(MNr) |

To determine the run times of the various methods, the scenario illustrated in FIG. 2 was utilized and the run times are presented in the Table 2. The results for both STFT and Hankel matrix transformation cases are shown. The inventors have determined that the input matrix size has a very significant impact on the run times of the methods. Initially, the received signal with interference has a length of 1×4160. After the STFT transformation, the obtained 2D matrix has size 64×86 and after the Hankel matrix lifting transformation, the obtained 2D matrix has size 2080×2081. Thus, Hankel matrix lifting based interference mitigation takes a much longer time because of its size and this can be clearly observed from the results in Table 2. ROSL can produce results in milliseconds even given this size of input data.

TABLE 2
Running time comparison of methods for both
STFT and HANKEL matrix transformation

| Method | STFT (sec.) | HANKEL (sec.) |
|---|---|---|
| RPCA | 1.42 | 4160 |
| IM-SPARKLE | — | 36.56 |
| ROSL | 0.019 | 13.46 |

After the run time analysis, the quantitative reconstruction quality of the methods was measured by using mean square error (MSE) and normalized MSE (NMSE) such as:

$$MSE = \frac{1}{N} {\sum }_{i = 1}^{N} {( target - {target}_{r} )}^{2} \qquad ( 8 )$$

$$NMSE = \frac{\frac{1}{N} {\sum }_{i = 1}^{N} {( target - {target}_{r} )}^{2}}{\frac{1}{N} {\sum }_{i = 1}^{N} {target}^{2}} \qquad ( 9 )$$

Table 3 shows the quantitative results of the methods for both STFT and Hankel matrix transformation in MSE. Table 4 shows the quantitative results of the methods for both STFT and Hankel matrix transformation in NMSE.

TABLE 3
Quantitative results of the methods for both
STFT and Hankel matrix transformation in MSE.

| Method | STFT (MSE) | HANKEL (MSE) |
|---|---|---|
| RPCA | 0.0075 | 0.0662 |
| IM-SPARKLE | — | 2.29e−4 |
| ROSL | 0.0056 | 1.87e−4 |

TABLE 4
Quantitative results of the methods for both STFT
and Hankel matrix transformation in NMSE.

| Method | STFT (NMSE) | HANKEL (NMSE) |
|---|---|---|
| RPCA | 0.0914 | 0.8066 |
| IM-SPARKLE | — | 0.0028 |
| ROSL | 0.0914 | 0.0023 |

As shown by the results in Tables 3 and 4, Hankel matrix transformation produces better reconstruction results compared to the STFT transformation. The ROSL and IM-SPARKLE methods have similar performance, with the ROSL method producing slightly better results than the IM-SPARKLE method. The RPCA method does not perform as well as the other methods. Thus, from the quantitative analysis, it is observed that these results are consistent with the visual results presented above.

In order to demonstrate the utility of the methods and systems described herein, results achieved using the Hankel matrix transformation are presented for different scenarios. In the following, only the IM-SPARKLE and ROSL methods are compared since their performance is similar.

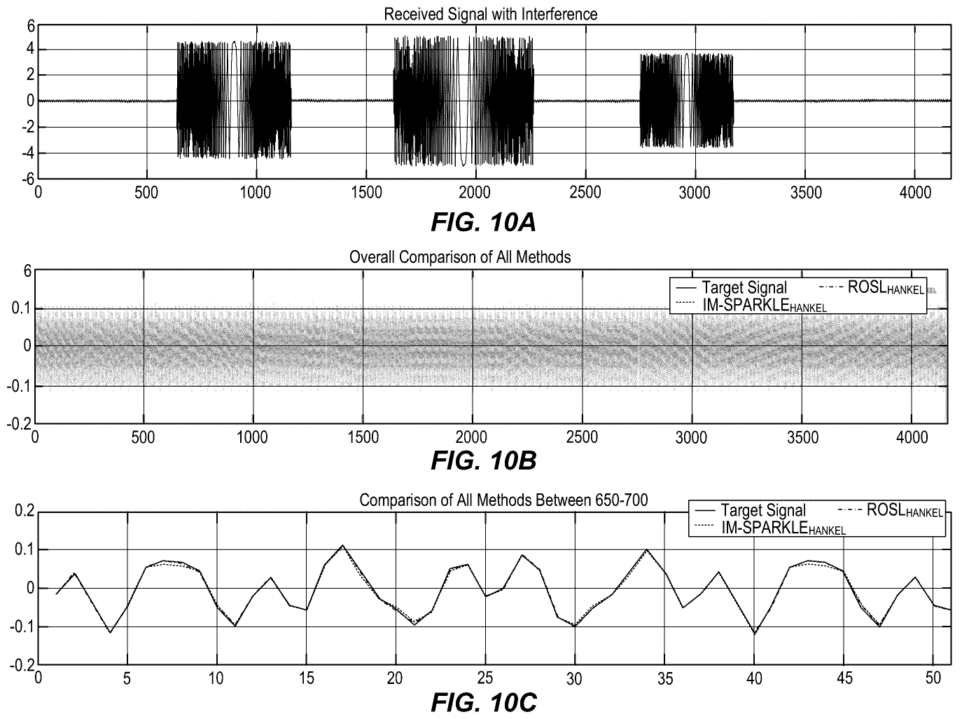

FIG. 10A is a plot illustrating a received signal with extreme interference according to an embodiment of the present invention. In contrast with the data plotted in FIG. 8A, the data plotted in FIG. 10 is characterized by heavy interference, with all the targets set as a weak target with very small reflection amplitude. As can be seen from the plot shown in FIG. 10A, the targets are barely observable since the interference is very heavy.

FIG. 10B is a plot illustrating target signals with no interference and mitigated signals according to an embodiment of the present invention. As discussed in relation to FIGS. 6B and 8B, the plot illustrated in FIG. 10B is for a reconstructed signal. As shown in FIG. 10B, IM-SPARKLE and ROSL methods are used for the LRSD purposes. Thus, in FIG. 10B, the overall reconstruction results of the IM-SPARKLE and ROSL methods are plotted along with the original target signal.

FIG. 10C a plot illustrating target signals with no interference and mitigated signals over a sample range according to an embodiment of the present invention. In FIG. 10C, the reconstructed signal over the sample range of 650-700 samples is illustrated, providing a zoomed version similar to that shown in FIGS. 6C and 8C to better illustrate the overlap between the original target signal and the reconstructed signal. As can be seen from the results, the results of the ROSL method produce better reconstruction results than the results of the IM-SPARKLE method.

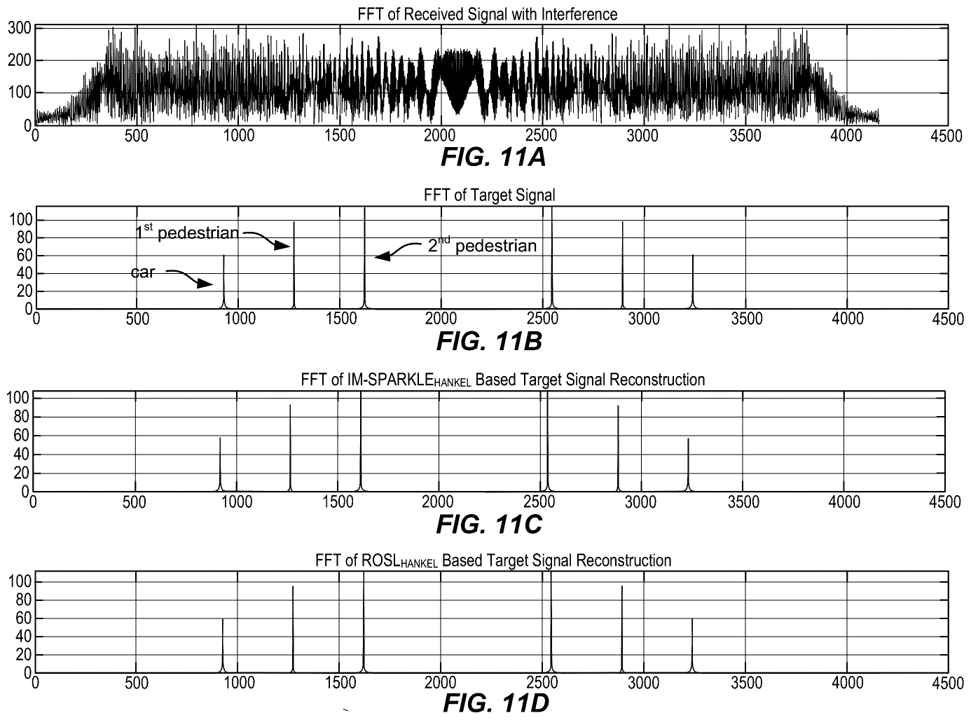

FIG. 11A is a plot illustrating the FFT of the received signal with interference according to an embodiment of the present invention. The FFT data shown in FIG. 11A corresponds to the received signal with interference shown in FIG. 10A. As can be seen from the data illustrated in FIG. 11A, the target signals corresponding to all targets are not observed in the data since there is a high noise floor.

FIG. 11B is a plot illustrating the FFT of the target signals with no interference according to an embodiment of the present invention. Thus, this plot provides a baseline, also referred to as a ground truth, against which the reconstructed signals can be compared.

FIG. 11C is a plot illustrating the FFT of the reconstructed target signal using the IM-SPARKLE method in the Hankel matrix lifting implementation according to an embodiment of the present invention. FIG. 11D is a plot illustrating the FFT of the reconstructed target signal using the ROSL method in the Hankel matrix lifting implementation according to an embodiment of the present invention.

As can be seen from these results, the reconstructed signals uncover the missing targets, which have almost the same amplitude as the original target signals. In fact, the reconstruction score of the ROSL method is almost three times better than the IM-SPARKLE method while be characterized by a run time five times better for this scenario.

In the scenario illustrated in FIGS. 11A-11D, one of the aggressor radar has the same slope with the victim radar. As seen in FIG. 11A, the interference covers all the target signals. The reconstruction results in FIGS. 11C and 11D show that the interference with the same slope has a significant impact on the reconstruction as expected.

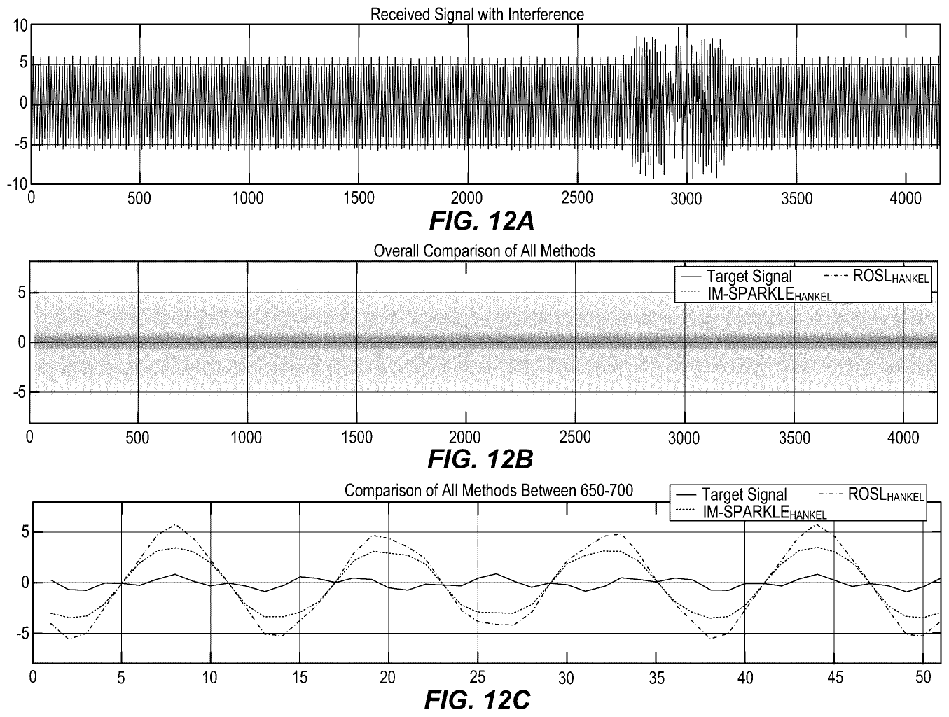

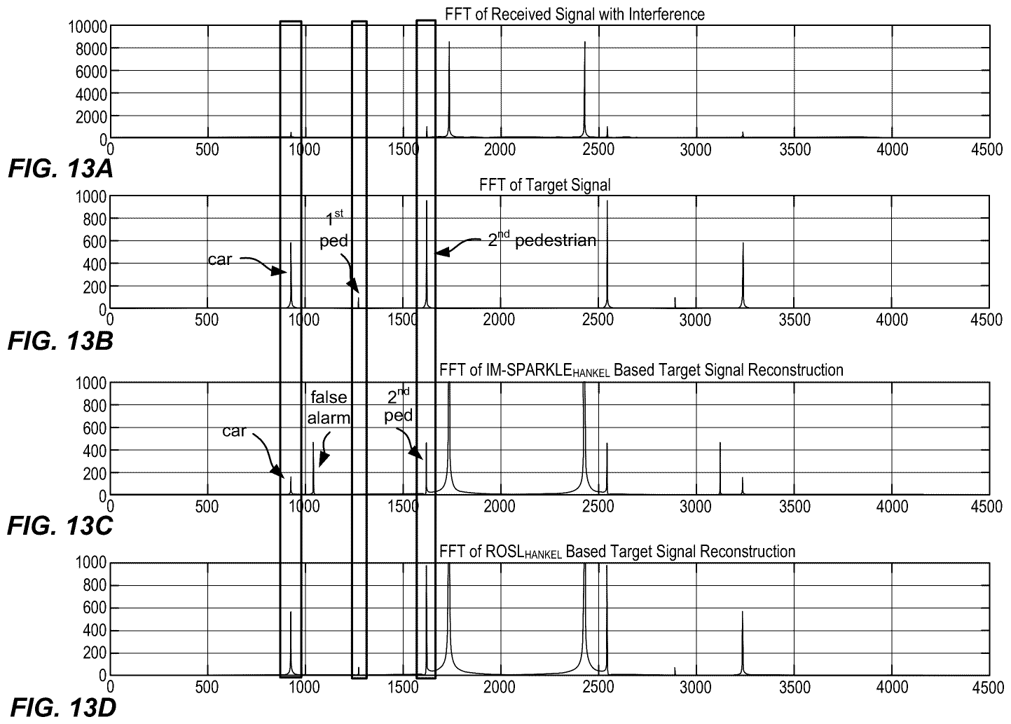

FIG. 12A is a plot illustrating a received signal with interference according to an embodiment of the present invention. The amplitude of the aggressor radar, which has the same slope with the victim radar, is shown as a ghost target with a very significant amplitude around 8000 samples. Thus, it suppresses the available target signatures. Therefore, FIG. 12A specifically shows the ghost target phenomenon, which means that the aggressor radar (i.e., the interference source) has the same slope as the victim radar (i.e., our radar).

FIG. 12B is a plot illustrating target signals with no interference and mitigated signals according to an embodiment of the present invention. As discussed in relation to FIGS. 6B, 8B, and 10B, the plot illustrated in FIG. 12B is for a reconstructed signal. As shown in FIG. 12B, IM-SPARKLE and ROSL methods are used for the LRSD purposes. Thus, in FIG. 12B, the overall reconstruction results of the IM-SPARKLE and ROSL methods are plotted along with the original target signal.

FIG. 12C a plot illustrating target signals with no interference and mitigated signals over a sample range according to an embodiment of the present invention. In FIG. 12C, the reconstructed signal over the sample range of 650-700 samples is illustrated, providing a zoomed version similar to that shown in FIGS. 6C, 8C, and 10C to better illustrate the overlap between the original target signal and the reconstructed signal.

FIG. 13A is a plot illustrating the FFT of the received signal with interference according to an embodiment of the present invention. The FFT data shown in FIG. 13A corresponds to the received signal with interference shown in FIG. 12A.

FIG. 13B is a plot illustrating the FFT of the target signals with no interference according to an embodiment of the present invention. Thus, this plot provides a baseline against which the reconstructed signals can be compared. Comparing the data in FIGS. 13A and 13B, the interference shown in FIG. 13A has signal amplitudes over 8000, which the target signal amplitudes are less than 1000 as illustrated in FIG. 13B. Thus, the targets are easily suppressed by the interference.

FIG. 13C is a plot illustrating the FFT of the reconstructed target signal using the IM-SPARKLE method in the Hankel matrix lifting implementation according to an embodiment of the present invention. FIG. 13D is a plot illustrating the FFT of the reconstructed target signal using the ROSL method in the Hankel matrix lifting implementation according to an embodiment of the present invention.

Referring to FIG. 13C, the IM-SPARKLE method detects the car (i.e., the signal at ˜950 samples) and the second pedestrian (i.e., the signal at ˜1600 samples), but misses the first pedestrian (i.e., the signal at ˜1300 samples in FIG. 13B). In addition, there is a false alarm located to the right side of the first target (i.e., the signal at ˜1050 samples) as shown in FIG. 13C. On the contrary, ROSL can detect all three targets in the same location with the similar amplitudes. Thus, because embodiments of the present invention can detect and successfully remove the ghost target, the target signals are easily detected by embodiments of the present invention Thus, it can be concluded that the ROSL presents satisfactory results for this scenario.

Interference Mitigation Example with Real Urban Measurements

The results of a real urban interference mitigation example is presented in this section. As discussed previously, first of all, the received signal is analyzed to determine whether there is interference present or not. Regarding the received radar signals, interference typically show up as time-limited artifacts with a very high amplitude. Therefore, their occurrence can be detected with energy detectors, matched filters, constant false alarm (CFAR) thresholding, and the like, but also methods from image processing can be utilized. For interference detection purposes, a detection scheme is implemented by using the statistical properties of the received signal with interference. This detection scheme is similar to CFAR methods.

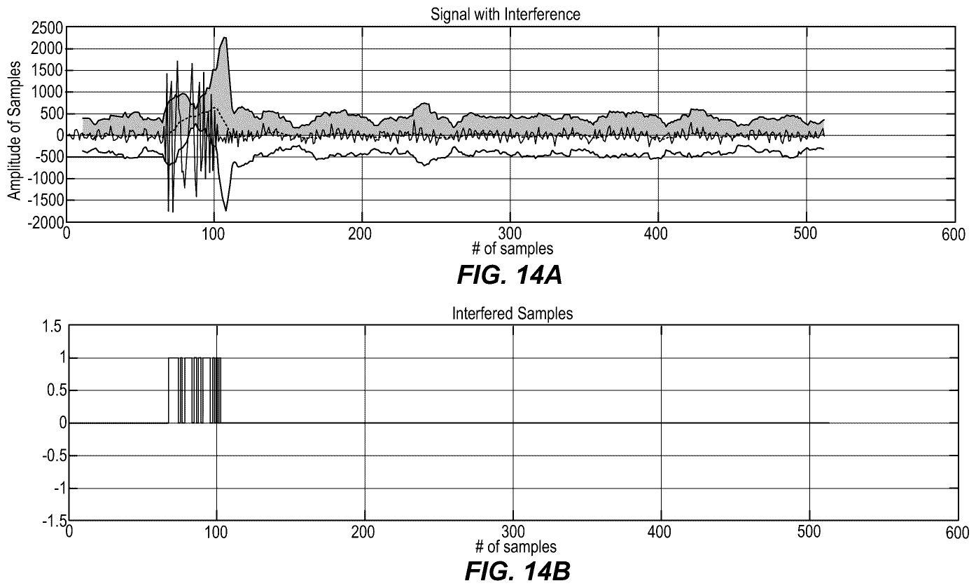

FIG. 14A is a plot illustrating the received signal with interference according to an embodiment of the present invention. In FIG. 14A, the region in which interference is present, which can be referred to as the interfered region, can be observed by visual inspection. To detect the interfered samples, a light-weight interference detection scheme is implemented that uses the statistical properties of the received signal, for example, the moving average and standard deviation. Samples out of the green boundaries in FIG. 14A can be accepted as interfered. FIG. 14B is a plot illustrating the location of interfered samples according to an embodiment of the present invention.

If the number of interfered samples are higher than a predefined threshold, the interference mitigation method is applied to the received signal. Otherwise, the samples are accepted as a clean signal.

In the example illustrated in FIG. 14A, the signal is interfered and it is detected by the interference detection method. Then, the next step is to apply one or more of the interference mitigation methods provided by embodiments of the present invention.

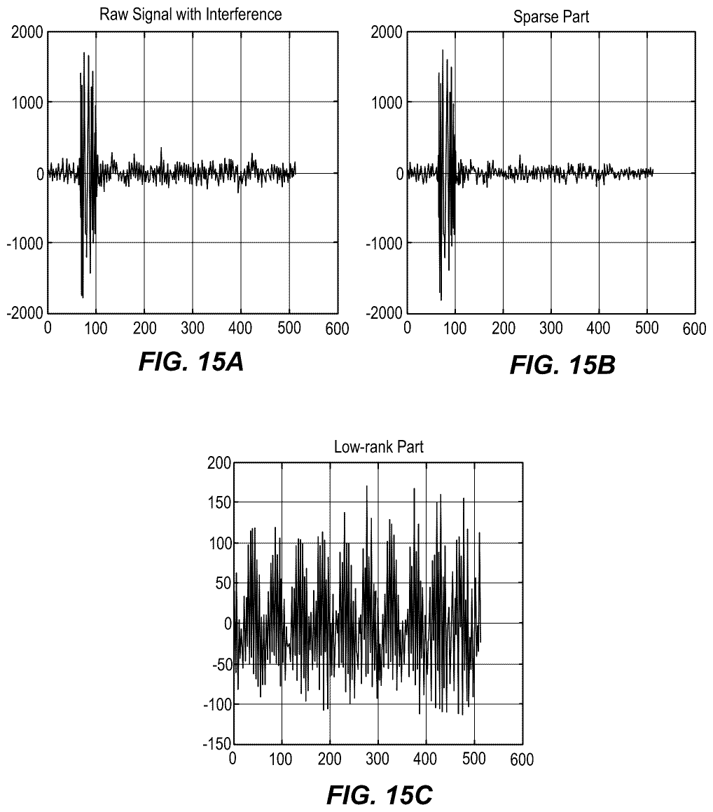

FIG. 15A is a plot illustrating a received signal with interference according to an embodiment of the present invention. The data shown in FIG. 15A are measured samples. FIG. 15B is a plot showing the decomposition of the sparse part of the received signal with interference according to an embodiment of the present invention. FIG. 15C is a plot showing the decomposition of the low-rank part of the received signal with interference according to an embodiment of the present invention.

Referring to FIGS. 15A-15C, the target signal, represented by the low-rank part illustrated in FIG. 15C, with a signal amplitude of the order of 100 is separated from the interference, represented by the sparse part illustrated in FIG. 15B, with a signal amplitude on the order of 1500. Thus, embodiments of the present invention are able to separate target signals, which would otherwise be suppressed by interference, from the receive signal.

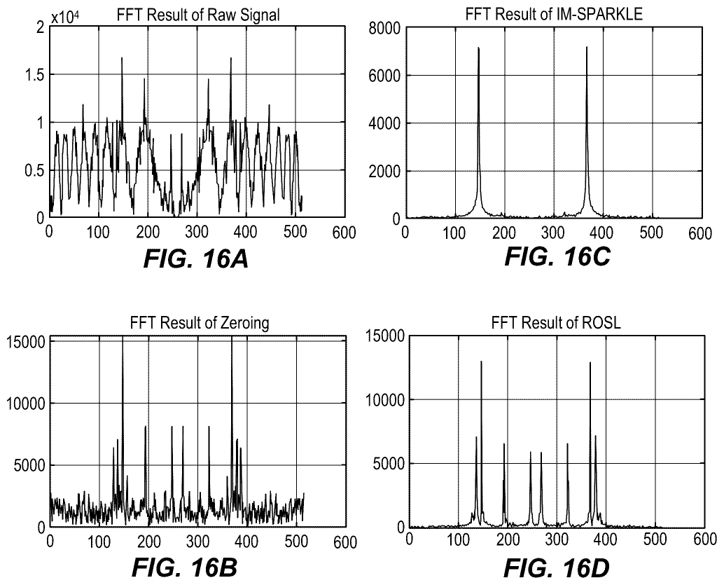

FIG. 16A is a plot illustrating the FFT of the received signal with interference according to an embodiment of the present invention. As shown in FIG. 16A, the presence of interference increases the noise floor and masks the target signatures.

FIG. 16B is a plot illustrating the FFT of the received signal with interference after application of a zeroing method. The zeroing method is heavily used as a baseline method for interference mitigation and other improved extrapolation versions are available. In the zeroing method, the interfered signal has to be detected carefully since they are equaled to zero. A limitation of the zeroing mitigation occurs for long interference windows because a large portion of the measurement is zeroed and thus, relevant signal information is lost. Besides, during the zeroing of the interference part, some useful target signals can also be zeroed. The zeroing method has high noise floors, but for this specific example, the interfered samples can be located by visual inspection as shown in FIG. 16B.

FIG. 16C is a plot illustrating the FFT of the received signal with interference after application of the IM-SPARKLE method according to an embodiment of the present invention. As illustrated in FIG. 16C, the IM-SPARKLE method successfully cleans the noise floors. However, it also removes the target signatures. Thus, the IM-SPARKLE method only keeps the main peak and removes all other signatures.

FIG. 16D is a plot illustrating the FFT of the received signal with interference after application of the ROSL method according to an embodiment of the present invention. As shown by the plot in FIG. 16D, the ROSL method preserves the peaks in the low-rank part and also suppresses the noise floor successfully. Thus, FIG. 16 demonstrates that the ROSL method can be successfully applied and provides a high level of performance for the real urban measurements.

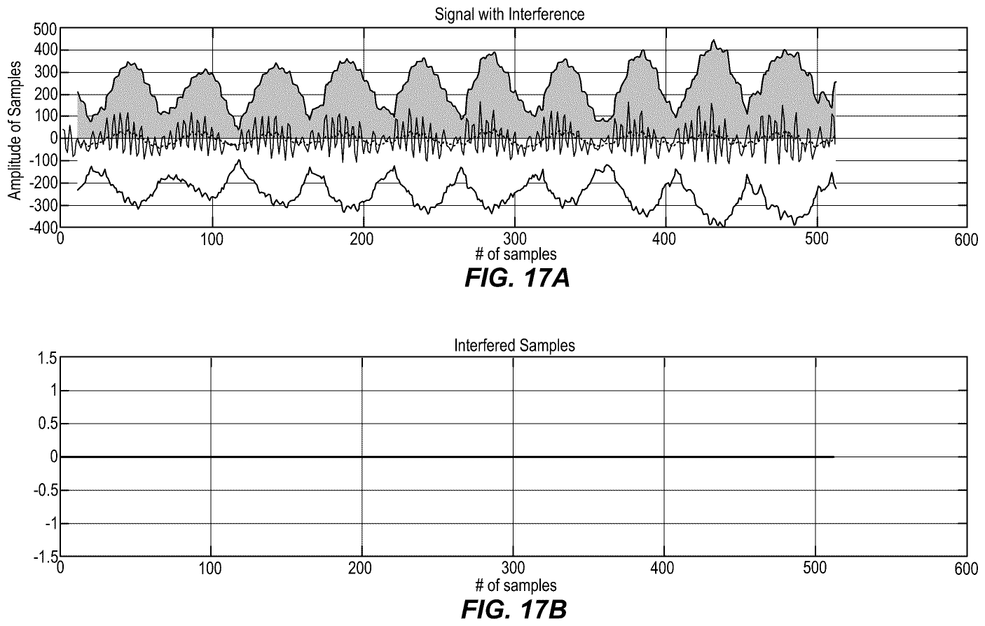

Finally, to show the effectiveness of the interference detection method, the target signal obtained via the ROSL method is used for test purposes. FIG. 17A is a plot illustrating a received signal with interference according to an embodiment of the present invention. FIG. 17B is a plot of interfered samples according to an embodiment of the present invention. In the process represented by FIGS. 17A and 17B, the target signal is fed to the interference detection module and the result is presented in FIG. 17B. However, there are no interfered signals in the output. Therefore, this signal does not need interference mitigation.

### Manifestation of Interference at Range-Doppler Map

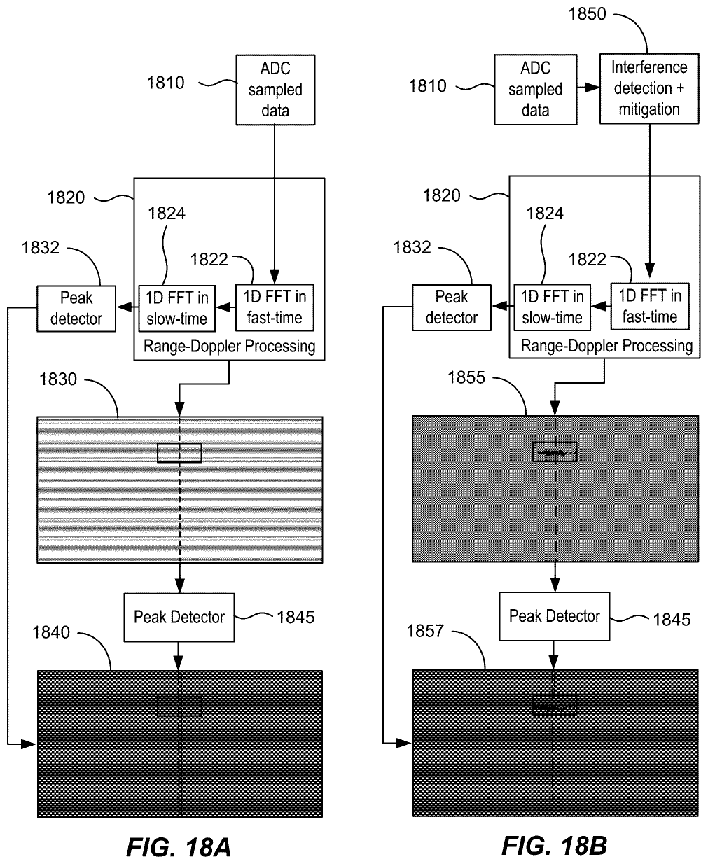

FIG. 18A is a simplified schematic diagram including data plots illustrating a conventional radar signal processing pipeline. As illustrated in FIG. 18A, the presence of the interference results in the targets being masked by the interference in the data that is produced after range-Doppler processing. In other words, using the range-Doppler processing method in the presence of interference, the target is not detected due to the presence of the heavy interference, which suppresses the target signature. As a result, the functionality of the peak detector is impaired in conventional systems.

Referring to FIG. 18A, the ADC sampled signal 1810 is received and processed the range-Doppler processing module 1820, which includes computing a 1D FFT in fast time (1822) and a 1D FFT in slow-time (1824). The output of the range-Doppler processing module 1820 is represented by scene 1830, in which the target is not detected, and is also input to peak detector 1832, which outputs scene 1840 in which the target is also not detected. Scene 1830 can be processed using peak detector 1845 to produce scene 1840 in which the target is also not detected.

FIG. 18B is a simplified schematic diagram including data plots illustrating a radar signal processing pipeline according to an embodiment of the present invention. Using the interference detection and/or mitigation methods described herein, removal of the interference signals to produce mitigated target signal data enables the targets to be detectable after range-Doppler processing and after peak detection. In particular, the ADC sampled signal 1810 is received and processed using interference detection and mitigation module 1850 prior to range-Doppler processing module 1820, which includes computing a 1D FFT in fast time (1822) and a 1D FFT in slow-time (1824). The output of the range-Doppler processing module 1820 is represented by scene 1855, in which the target is detected, and is also input to peak detector 1832, which outputs scene 1857 in which the target is also detected. Scene 1855 can be processed using peak detector 1845 to produce scene 1857 in which the target is also detected. Thus, using embodiments of the present invention, the operation of the radar pipeline is enhanced in comparison with conventional techniques.

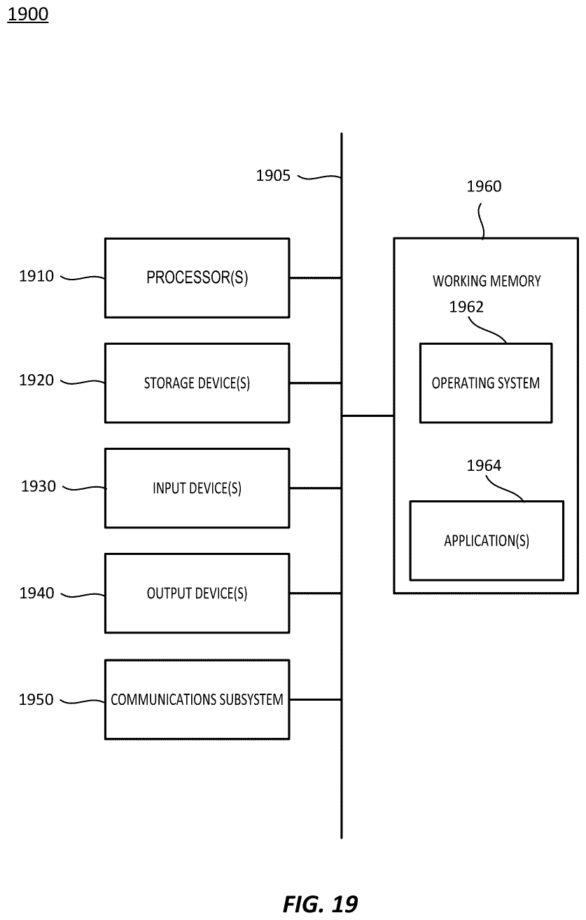

FIG. 19 is a simplified block diagram illustrating components of a radar signal processing according to an embodiment of the present invention. Radar signal processing system 1900 as illustrated in FIG. 19 may be incorporated into a vehicle or other suitable platform utilizing radar data as described herein. FIG. 19 provides a schematic illustration of one embodiment of radar signal processing system 1900 that can perform some or all of the steps of the methods provided by various embodiments. It should be noted that FIG. 19 is meant only to provide a generalized illustration of various components, any or all of which may be utilized as appropriate. FIG. 19, therefore, broadly illustrates how individual system elements may be implemented in a relatively separated or relatively more integrated manner.

Radar signal processing system 1900 is shown comprising hardware elements that can be electrically coupled via a bus 1905, or may otherwise be in communication, as appropriate. The hardware elements may include one or more processors 1910, including without limitation one or more general-purpose processors and/or one or more special-purpose processors such as digital signal processing chips, graphics acceleration processors, and/or the like; one or more input devices 1930, which can include without limitation a radar, a mouse, a keyboard, a camera, and/or the like; and one or more output devices 1940, which can include without limitation a display device, a printer, and/or the like. Utilizing one or more processors 1910, the received radar signals can be processed to detect targets in the presence of interference as discussed herein can be implemented.

Radar signal processing system 1900 may further include and/or be in communication with storage device(s) 1920 (e.g., one or more non-transitory storage devices), which can comprise without limitation local and/or network accessible storage, and/or can include without limitation a disk drive, a drive array, an optical storage device, a solid-state storage device such as a random access memory (RAM) and/or a read-only memory (ROM) which can be programmable, flash-updateable, and/or the like. Such storage devices may be configured to implement any appropriate data stores including without limitation various file systems, database structures, and/or the like.

Radar signal processing system 1900 might also include a communications subsystem 1950, which can include without limitation a modem, a network card (wireless or wired), an infrared communication device, a wireless communication device, and/or a chipset such as a Bluetooth™ device, an 802.11 device, a WiFi device, a WiMax device, cellular communication facilities, etc., and/or the like. Communications subsystem 1950 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate radar and/or image and/or other information via communications subsystem 1950. In other embodiments, a portable electronic device, e.g., the first electronic device, may be incorporated into radar signal processing system 1900, e.g., an electronic device as an input device 1930. In some embodiments, radar signal processing system 1900 will further comprise a working memory 1960, which can include a RAM or ROM device, as described above.

Radar signal processing system 1900 also can include software elements, shown as being currently located within working memory 1960, including an operating system 1962, device drivers, executable libraries, and/or other code, such as one or more application programs 1964, which may comprise computer programs provided by various embodiments, and/or may be designed to implement methods, and/or configure systems, provided by other embodiments, as described herein. Merely by way of example, one or more procedures described with respect to the methods discussed above might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as storage device(s) 1920 described above. In some cases, the storage medium might be incorporated within a computer system, such as radar signal processing system 1900. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by radar signal processing system 1900 and/or might take the form of source and/or installable code, which, upon compilation and/or installation on radar signal processing system 1900, e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as radar signal processing system 1900 to perform methods in accordance with various embodiments of the technology. According to a set of embodiments, some or all procedures of such methods are performed by radar signal processing system 1900 in response to one or more processors 1910 executing one or more sequences of one or more instructions, which might be incorporated into operating system 1962 and/or other code, such as an application program 1964, contained in working memory 1960. Such instructions may be read into working memory 1960 from another computer-readable medium, such as one or more of storage device(s) 1920. Merely by way of example, execution of the sequences of instructions contained in working memory 1960 might cause one or more processors 1910 to perform one or more procedures of the methods described herein. Additionally, or alternatively, portions of the methods described herein may be executed through specialized hardware.

The terms machine-readable medium and computer-readable medium, as used herein, refer to any medium that participates in providing data that causes a machine to operate in a specific fashion. In an embodiment implemented using radar signal processing system 1900, various computer-readable media might be involved in providing instructions/code to one or more processors 1910 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as storage device(s) 1920. Volatile media include, without limitation, dynamic memory, such as working memory 1960.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to one or more processors 1910 for execution. Merely by way of example, the instructions may initially be carried on a magnetic disk and/or optical disc of a remote computer. A remote computer might load the instructions into its dynamic memory and send the instructions as signals over a transmission medium to be received and/or executed by radar signal processing system 1900.

Communications subsystem 1950 and/or components thereof generally will receive signals, and bus 1905 then might carry the signals and/or the data, instructions, etc. carried by the signals to working memory 1960, from which one or more processors 1910 retrieves and executes the instructions. The instructions received by working memory 1960 may optionally be stored on storage device(s) 1920, e.g., a non-transitory storage device, either before or after execution by one or more processors 1910.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is method of processing radar data, the method comprising: detecting a received signal including one or more targets signals and interference; converting the received signal to a matrix signal; decomposing the matrix signal into a low-rank matrix and a sparse matrix using a group sparsity based low-rank and sparse decomposition method; computing an inverse transform of the low-rank matrix; and outputting the one or more target signals.

Example 2 is the method of example 1 wherein the received signal comprises a one-dimensional signal and the matrix signal comprises a two-dimensional signal.

Example 3 is the method of example(s) 1-2 wherein converting the received signal to a matrix signal comprises performing a short time Fourier transform on the received signal.

Example 4 is the method of example(s) 1-3 wherein the inverse transform comprises an inverse short time Fourier transform.

Example 5 is the method of example(s) 1-4 wherein converting the received signal to a matrix signal comprises performing Hankel matrix lifting on the received signal.

Example 6 is the method of example(s) 1-5 wherein the inverse transform comprises an inverse Hankel matrix lifting.

Example 7 is the method of example(s) 1-6 wherein the low-rank matrix corresponds to the one or more target signals.

Example 8 is the method of example(s) 1-7 wherein the sparse matrix corresponds to the interference.

Example 9 is the method of example(s) 1-8 wherein the interference corresponds to three or more interference sources.

Example 10 is the method of example(s) 1-9 further comprising determining that interference is present in the received signal.

Example 11 is the method of example(s) 1-10 wherein determining that interference is present in the received signal comprises using a constant false alarm method.

Example 12 is a system comprising: a processor; and a non-transitory computer-readable storage medium coupled to the processor and comprising a plurality of computer-readable instructions tangibly embodied on the non-transitory computer-readable storage medium, which, when executed by the processor, process radar data, the plurality of computer-readable instructions comprising: instructions that cause the processor to detecting a received signal including one or more targets signals and interference; instructions that cause the processor to convert the received signal to a matrix signal; instructions that cause the processor to decompose the matrix signal into a low-rank matrix and a sparse matrix using a group sparsity based low-rank and sparse decomposition method; instructions that cause the processor to compute an inverse transform of the low-rank matrix; and instructions that cause the processor to output the one or more target signals.

Example 13 is the system of example 12 wherein the received signal comprises a one-dimensional signal and the matrix signal comprises a two-dimensional signal.

Example 14 is the system of example(s) 12-13 wherein the instructions that cause the processor to convert the received signal to a matrix signal comprise instructions that cause the processor to perform a short time Fourier transform on the received signal.

Example 15 is the system of example(s) 12-14 wherein the inverse transform comprises an inverse short time Fourier transform.

Example 16 is the system of example(s) 12-15 wherein the instructions that cause the processor to convert the received signal to a matrix signal comprises instructions that cause the processor to perform Hankel matrix lifting on the received signal.

Example 17 is the system of example(s) 12-16 wherein the inverse transform comprises an inverse Hankel matrix lifting.

Example 18 is the system of example(s) 12-17 wherein the low-rank matrix corresponds to the one or more target signals.

Example 19 is the system of example(s) 12-18 wherein the sparse matrix corresponds to the interference.

Example 20 is the system of example(s) 12-19 wherein the interference corresponds to three or more interference sources.

Example 21 is the system of example(s) 12-20 wherein the plurality of computer-readable instructions further comprising instructions that cause the processor to determine that interference is present in the received signal.

Example 22 is the system of example(s) 12-21 wherein the instructions that cause the processor to determine that interference is present in the received signal implement a constant false alarm method.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of processing radar data, the method comprising:
detecting a received signal including one or more targets signals and interference;
converting the received signal to a matrix signal;
decomposing the matrix signal into a low-rank matrix and a sparse matrix using a group sparsity based low-rank and sparse decomposition method;
computing an inverse transform of the low-rank matrix; and
outputting the one or more target signals.

2. The method of claim 1 wherein the received signal comprises a one-dimensional signal and the matrix signal comprises a two-dimensional signal.

3. The method of claim 1 wherein converting the received signal to a matrix signal comprises performing a short time Fourier transform on the received signal.

4. The method of claim 3 wherein the inverse transform comprises an inverse short time Fourier transform.

5. The method of claim 1 wherein converting the received signal to a matrix signal comprises performing Hankel matrix lifting on the received signal.

6. The method of claim 5 wherein the inverse transform comprises an inverse Hankel matrix lifting.

7. The method of claim 1 wherein the low-rank matrix corresponds to the one or more target signals.

8. The method of claim 1 wherein the sparse matrix corresponds to the interference.

9. The method of claim 1 wherein the interference corresponds to three or more interference sources.

10. The method of claim 1 further comprising determining, using a constant false alarm method, that interference is present in the received signal.

11. A system comprising:
a processor; and
a non-transitory computer-readable storage medium coupled to the processor and comprising a plurality of computer-readable instructions tangibly embodied on the non-transitory computer-readable storage medium, which, when executed by the processor, process radar data, the plurality of computer-readable instructions comprising:
instructions that cause the processor to detecting a received signal including one or more targets signals and interference;
instructions that cause the processor to convert the received signal to a matrix signal;
instructions that cause the processor to decompose the matrix signal into a low-rank matrix and a sparse matrix using a group sparsity based low-rank and sparse decomposition method;
instructions that cause the processor to compute an inverse transform of the low-rank matrix; and
instructions that cause the processor to output the one or more target signals.

12. The system of claim 11 wherein the received signal comprises a one-dimensional signal and the matrix signal comprises a two-dimensional signal.

13. The system of claim 11 wherein the instructions that cause the processor to convert the received signal to a matrix signal comprise instructions that cause the processor to perform a short time Fourier transform on the received signal.

14. The system of claim 13 wherein the inverse transform comprises an inverse short time Fourier transform.

15. The system of claim 11 wherein the instructions that cause the processor to convert the received signal to a matrix signal comprises instructions that cause the processor to perform Hankel matrix lifting on the received signal.

16. The system of claim 15 wherein the inverse transform comprises an inverse Hankel matrix lifting.

17. The system of claim 11 wherein the low-rank matrix corresponds to the one or more target signals.

18. The system of claim 11 wherein the sparse matrix corresponds to the interference.

19. The system of claim 11 wherein the interference corresponds to three or more interference sources.

20. The system of claim 11 wherein the plurality of computer-readable instructions further comprising instructions that cause the processor to determine, using a constant false alarm method, that interference is present in the received signal.
